(19) United States
(12) Patent Application Publication
(10) Pub. No.: US 2016/0219332 A1
(43) Pub. Date: Jul. 28, 2016

(54) VERIFICATION OF AD IMPRESSIONS IN USER-ADAPTIVE MULTIMEDIA DELIVERY FRAMEWORK

(71) Applicant: INTERDIGITAL PATENT HOLDINGS, INC., Wilmington, DE (US)

(72) Inventors: Eduardo Asbun, San Diego, CA (US); Kari Kailamaki, Mercer Island, WA (US); Yuriy Reznik, Seattle, WA (US); Ariela Zeira, Huntington, NY (US); Allen Proithis, Lancaster, PA (US); Gregory S. Sternberg, Mt. Laurel, NJ (US); Rahul Vanam, San Diego, CA (US); Liangping Ma, San Diego, CA (US)

(73) Assignee: InterDigital Patent Holdings, Inc., Wilmington, DE (US)

(21) Appl. No.: 15/023,367

(22) PCT Filed: Sep. 19, 2014
(86) PCT No.: PCT/US2014/056663

§ 371 Date: Mar. 18, 2016

Related U.S. Application Data
(60) Provisional application No. 61/880,815, filed on Sep. 20, 2013.
(60) Provisional application No. 61/892,422, filed on Oct. 17, 2013.

(51) Int. Cl. H04N 21/442; H04N 21/2668; H04N 21/466; H04N 21/81; H04N 21/45

(52) U.S. Cl. CPC H04N 21/44218; H04N 21/812; H04N 21/4532; H04N 21/4667; H04N 21/2668

(57) ABSTRACT

Embodiments contemplate detection, estimation, and/or adaptation to user presence, proximity and/or ambient lighting conditions. Embodiments also contemplate user proximity estimation based on input from sensors in mobile devices. Embodiments further contemplate volume control and/or audio bitstream selection based on an estimate of one or more of these parameters: user's location, age, gender, ambient noise level and/or multiple users. Also, embodiments contemplate detection, estimation, and/or adaptation to user presence and/or user attention to advertisements delivered via various mechanisms, perhaps at various locations.

### CROSS-REFERENCE TO RELATED APPLICATIONS

This application claims the benefit of U.S. Provisional Application No. 61/880,815, titled “Verification of Ad Impressions in User-Adaptive Multimedia Delivery Framework”, filed on Sep. 20, 2013, and U.S. Provisional Application No. 61/892,422, titled “Verification of Ad Impressions in User-Adaptive Multimedia Delivery Framework”, filed on Oct. 17, 2013, the disclosures of bath applications hereby incorporated by reference in their respective entirety as if fully disclosed herein, for all purposes.

### BACKGROUND

Embodiments recognize advertising and ad insertion in television. Since its inception, television has been used to show product advertisements. In its modern form, advertising occurs during breaks over the duration of a show. In the U.S., advertising rates are determined primarily by Nielsen ratings, an audience measurement system that uses statistical sampling to estimate viewership. Nielsen uses indirect means to estimate viewership, as they only record the time and channel the TV is tuned to, but have no techniques to determine whether viewers were actually present.

### SUMMARY

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments contemplate the design of a system for ad impression verification in adaptive multimedia delivery systems employing adaptation to user behavior and viewing conditions.

One or more embodiments described herein can be used in multimedia delivery systems for mobile devices (e.g., smart phones, tablets, laptops) and home devices such as set-top boxes, streaming devices (e.g., Chromecast, Roku, Apple TV), gaining consoles (e.g., XBox and PlayStation), consumer/commercial TVs and SmartTVs, and Personal Computers. One or more embodiments may support the use of existing multimedia delivery frameworks including, but not limited to, IPTV, progressive download, bandwidth adaptive streaming standards (such as MPEG and 3GPP DASH) and existing streaming technologies such as Apple's HTTP Live Streaming.

Embodiments contemplate detection, estimation, and/or adaptation to user presence, proximity and/or ambient lighting conditions. Embodiments also contemplate user proximity estimation based on input from sensors in mobile devices. Embodiments further contemplate volume control and/or audio bitstream selection based on an estimate of one or more of these parameters: user's location, age, gender, ambient noise level and/or multiple users. Also, embodiments contemplate detection, estimation and/or adaptation to user presence and/or attention to advertisements delivered via various mechanisms, perhaps at various locations.

Embodiments contemplate one or more techniques for determining a media. content impression, where the media content may be communicated via a communication network to a client device. Techniques may include receiving, from the client device, a first data that may correspond to a user proximate to the client device during a period of time. Techniques may also include receiving, from the client device, a second data corresponding to a state of the client device during the period of time. Techniques may include receiving, from the client device, an indication of at least one specific media content presented by the client device during the period of time. Techniques may also include determining a measurement of a user impression of the at least one specific media content based on the first data and the second data. The measurement of the user impression may provide an indication of a user attention to the at least one specific media content during the period of time.

Embodiments contemplate a wireless transmit/receive unit (WTRU) in communication with a wireless communication network. The WTRU may comprise a processor that may be configured to identify a first data corresponding to a user proximate to the WTRU during a period of time. The processor may be configured to identify a second data corresponding to a state of the WIRE during the period of time. The processor may be configured to determine at least one specific media content presented by the WTRU during the period of time. The processor may be configured to determine a measurement of a user impression of the at least one specific media content based on the first data and the second data. The measurement of the user impression may provide an indication of a user attention to the at least one specific media content during the period of time.

Embodiments contemplate one or more techniques for modifying a media content, where the media content may be communicated via a communication network to a client device. Techniques may include receiving, from the client device, a first data corresponding to a user proximate to the client device during a period of time. Techniques may include receiving, from the client device, an indication of at least one specific media content presented by the client device during the period of time. Techniques may include determining an adjustment of the at least one specific media content based on the first data. The adjustment may form an adjusted specific media content. Techniques may include providing the adjusted specific media content to the client device during at least one of: the period of time or another period of time.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 1D is a system diagram of another example radio access network and an example core network that may be used within the communications system illustrated in FIG. 1A;

FIG. 1E is a system diagram of another example radio access network and an example core network that may be used within the communications system illustrated in FIG. 1A;

FIG. 1F is an illustration of an example high-level diagram of a multimedia delivery system consistent with embodiments;

FIG. 2 is an illustration of an example ad insertion using splicing in digital TV consistent with embodiments;

FIG. 3 is an illustration of an example of system diagram for ad impression verification signaled to the content provider, consistent with embodiments;

FIG. 4A is an illustration of an example system diagram for ad impression verification signaled to an Ad Agency Server, consistent with embodiments;

FIG. 4B is an illustration of an example system diagram for ad impression verification signaled to the content provider using a proxy at the client, consistent with embodiments;

FIG. 4C is an illustration of an example system diagram for ad impression verification signaled to Ad Agency Server using a proxy at the client, consistent with embodiments;

FIG. 5 is an illustration an example implementation of user presence detection using camera or imaging devices, consistent with embodiments;

FIG. 6 is an illustration of a flowchart of an example implementation of user presence detection using sensors, consistent with embodiments;

FIG. 7 is an illustration of a flowchart of an example implementation of user presence detection by inferring user state from his/her input, consistent with embodiments;

FIG. 8 is an illustration of a diagram with an example system architecture that may implement server side user presence detection, consistent with embodiments;

FIG. 9 is an illustration of example encoded streams played by a multimedia client residing in a mobile device, consistent with embodiments;

FIG. 10 is an illustration of an example of a multimedia presentation description with an advertisement, consistent with embodiments;

FIG. 11 is an illustration of an example computation of an attention score for ad impression verification, consistent with embodiments;

FIG. 12 is an illustration of an example of an analysis period covering the time an advertisement plays, consistent with embodiments;

FIG. 13 is an illustration of an example of a variation of the number of faces detected over the analysis period, consistent with embodiments;

FIG. 14 is an illustration of an example of an algorithm that may be used for viewer detection, consistent with embodiments;

FIG. 15 is an illustration of an example classifier technique that may be used to determine a device state, consistent with embodiments; and

FIG. 16 is an illustration of an example of a classifier technique that may be used to obtain an attention score, consistent with embodiments.

### DETAILED DESCRIPTION OF ILLUSTRATIVE EMBODIMENTS

A detailed description of illustrative embodiments will now be described with reference to the various Figures. Although this description provides a detailed example of possible implementations, it should be noted that the details are intended to be exemplary and in no way limit the scope of the application. As used herein, the articles “a” and “an”, absent further qualification or characterization, may be understood to mean “one or more” or “at least one”, for example.

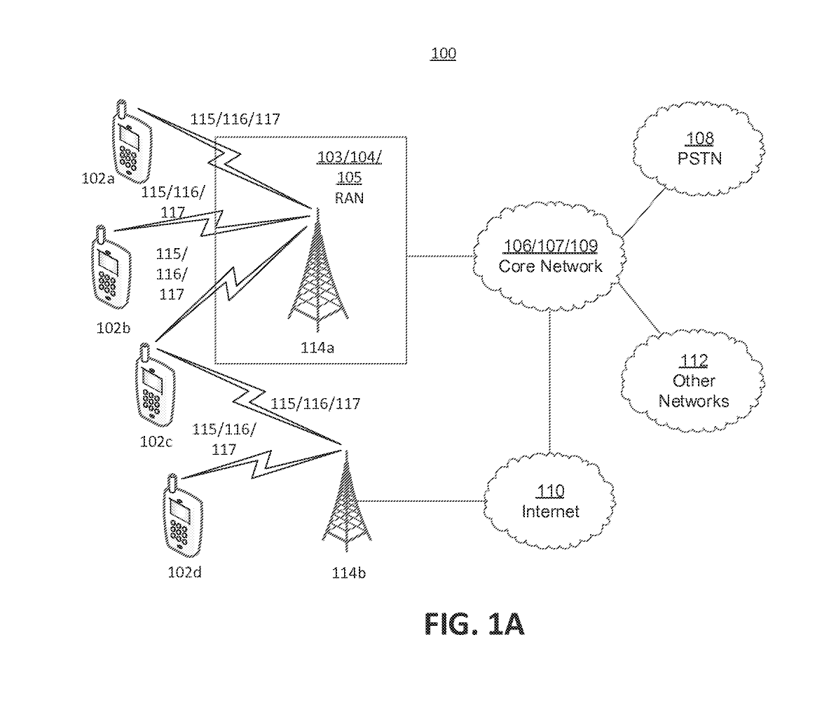

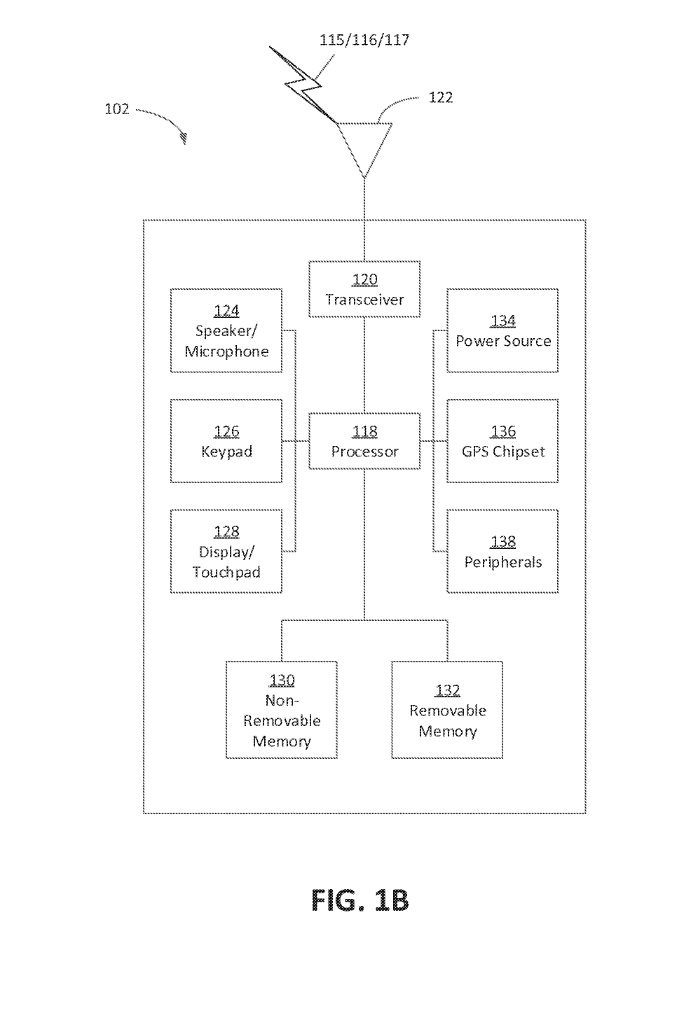

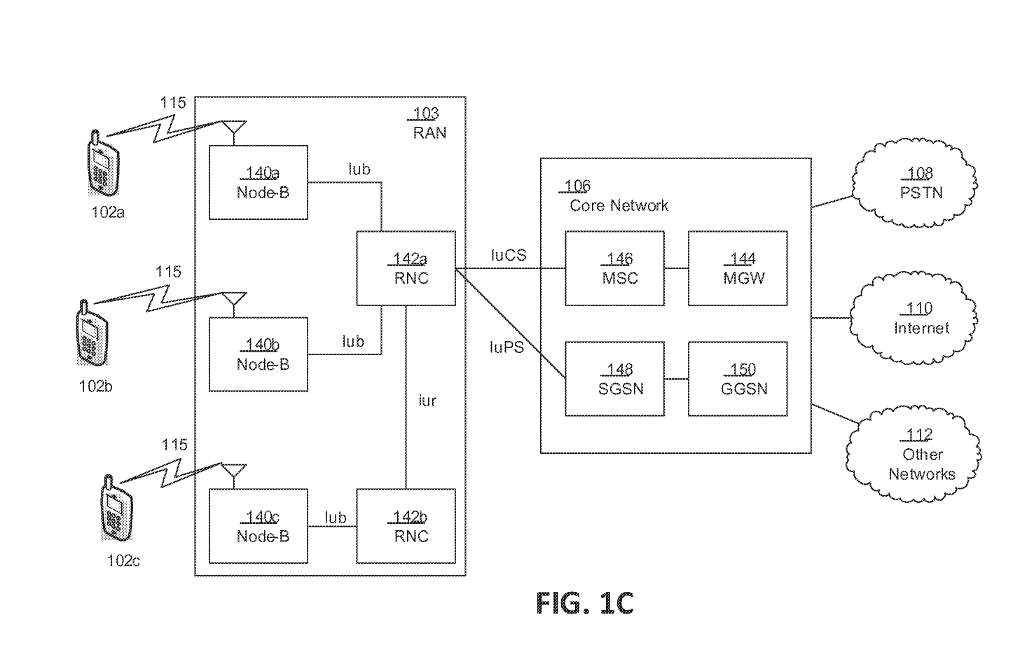

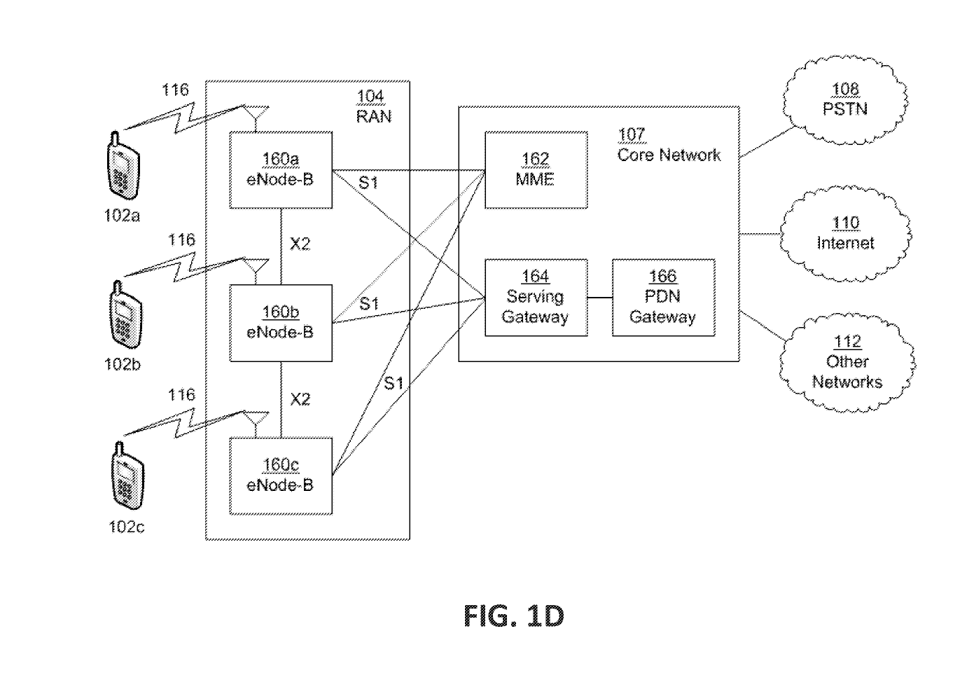

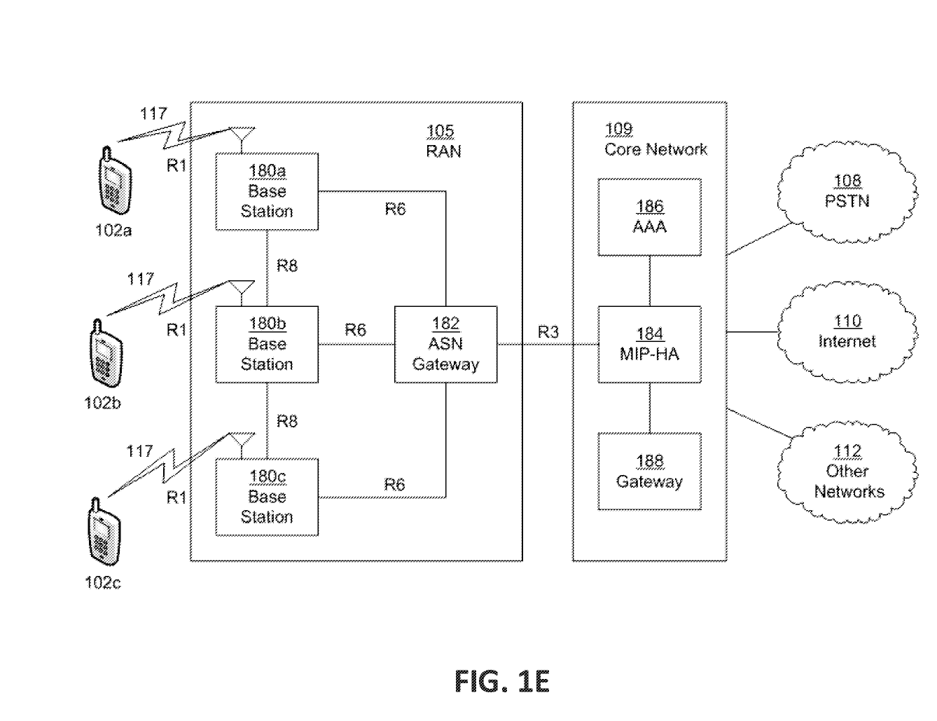

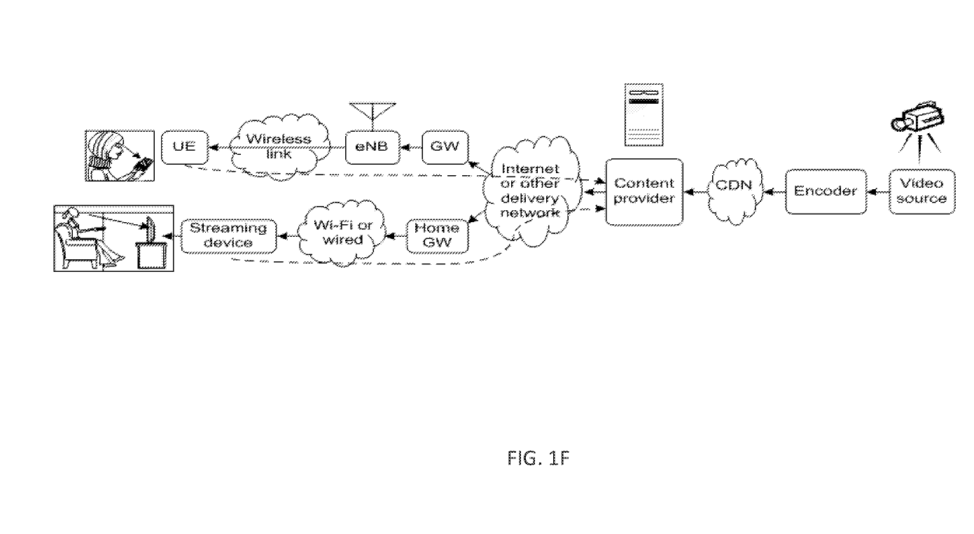

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102h, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117 which may be any suitable wireless communication link (e.g., radio frequency (RE), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LIE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102h, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, i.e., the WTRUs 102a, 102h, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RE signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MEMO technology. Thus, in one embodiment, the WIRE 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any, type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a. 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102h, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b. 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102h, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b; 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c, may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Embodiments contemplate viewing conditions adaptive multimedia delivery. Embodiments contemplate a system for multimedia delivery system which may use information about a user's viewing conditions to adapt encoding and/or a delivery process, perhaps for example to minimize usage of network bandwidth, power, and/or other system resources. The system may use sensors (e.g., front-faced camera, ambient light sensor, accelerometer, etc.) of the user equipment (e.g., smart phone or tablet) to detect the presence of the viewer. The adaptation system may use this information to determine parameters of visual content that a viewer may be able to see, and may adjust encoding and delivery parameters accordingly. This adaptation mechanism may allow the delivery system to achieve an improved (e.g., best) possible user experience, while perhaps saving network bandwidth and/or other system resources. Embodiments contemplate detection and/or adaptation to a user presence, perhaps using one or more sets of techniques to accommodate one or more sets of sensors (e.g., IR remote control, range finder, TV camera, smart phone or tablets used as remote controls and/or second screens, etc.) and/or capabilities available at home. A high-level diagram of an example bandwidth adaptive multimedia system for delivering content on a mobile and/or a home device is shown in FIG. 1F.

Embodiments contemplate that user presence, proximity to screen, and/or attention to video content can be established, perhaps using built-in sensors (camera accelerometer, etc.) in mobile devices and/or using built-in sensors in TV, set-top box, remote control, or other TV-attached devices (game consoles, Kinect, etc.) in home environment, among other environments. Information about user presence and/or proximity can be used to optimize multimedia delivery.

Embodiments recognize advertising and/or ad insertion in television. Since its inception, television has been used to show product advertisements. In its modern form, advertising occurs during breaks over the duration of a show. In the U.S., advertising rates are determined primarily by Nielsen ratings, which is an audience measurement system that uses statistical sampling to estimate viewership. The Nielsen system uses indirect means to estimate viewership, as it only records the time and channel to which the TV is tuned. But the Nielsen ratings have no techniques to determine whether viewers were actually present or how viewers may be responding to what they are seeing.

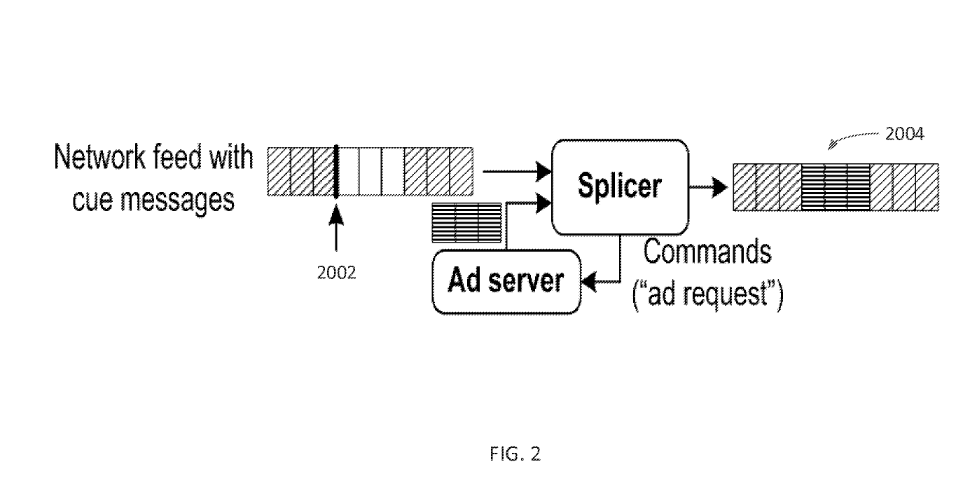

TV networks may distribute content to local affiliates and cable TV providers nationwide. These TV streams may carry advertisements meant to be shown at the national level, but also may allow for regional and/or local ads to be inserted in the stream. In analog TV, in-band dual-tone multi-frequency (DTMF) subcarrier audio “cue tones” may be used to trigger the cutover from a show and/or national ad to regional and/or local ads. In digital TV (e.g., IPTV), embodiments recognize that the Society of Cable Telecommunications Engineers (SCTE) has developed a set of standards for digital program insertion (e.g., SCTE 30 and 35) that may be used to (e.g., seamlessly) insert ads in TV systems by means of digital “cue messages”, as shown in FIG. 2. In FIG. 2, the cue message 2002 may indicate to the Splicer to insert the Ad server content to form the output stream 2004.

Embodiments recognize online advertising and ad insertion in Digital Media Delivery. A large number of web sites hosting media content (e.g., YouTube, Hulu, Facebook, CBS, Yahoo, etc.) may obtain revenue by showing advertisements to users during a multimedia delivery session (e.g., progressive download or streaming). Ads may be shown at the beginning (“pre-roll”), end (“post-roll”), and/or during (“mid-roll”) the delivery session. There may be certain rules that may be inserted to alter a user's control of the playback, perhaps for example when a video ad may be rendered, among other scenarios. For example, users may be prevented from skipping and/or fast-forwarding through the ad.

Embodiments recognize one or more different models by which advertisers may compensate web publishers for inserting ads in their content. In the “CPM” model, advertisers may pay for every thousand displays of their message to potential customers (e.g., Cost Per M, where M is Roman numeral standing for thousand). One or more, or each instance when an ad was displayed may be called an “impression” and the accuracy of counting and/or verification of such impressions may be useful to gauge. Embodiments contemplate that an impression that can be verified as one that was watched by the viewer might be worth more than an impression that may have no certainty of reaching the viewer's attention. Embodiments recognize other compensation models such as the “cost per click” (“CPC”) and/or the “cost per action” (“CPA”) models.

Embodiments contemplate Online Advertising and Ad Impression Verification. Embodiments recognize that a number of agencies and associations measure ad impressions and to develop techniques that measure ad impressions. Some are:
The Interactive Advertising Bureau (IAB) which is comprised of media and technology companies that are responsible for selling 86% of online advertising in the United States. The IAB evaluates and recommends standards and practices and for interactive advertising;
The Association of National Advertisers (ANA), which represents companies that collectively spend over 8250 billion in marketing and advertising;
The American Association of Advertising Agencies (AAAA or “4A's”), which is the national trade association representing the advertising agency business in the United States; and
The Media Rating Council (MRC) which issues accreditation for audience measurement services by ensuring metrics are valid, reliable and effective.

Embodiments recognize that the IAB describes a detailed set of methods and common practices for ad verification, although it focuses on techniques related to image ads, such as determining whether an ad has been served (e.g., using cookies or invisible/transparent images), whether the page with ads was requested by a human (to prevent fraud by inflating the number of impressions), or by determining the location of an ad within a web page (e.g., visible by the user on page load, referred to as “above the fold”).

In broadcast and cable TV, embodiments recognize that it presently might not be possible to verify ad impressions in a direct manner because there is no built-in feedback mechanism in the content delivery system (e.g., via a content delivery network (CDN)). In video streaming for laptops and PCs with internee connection, embodiments recognize that some attempts have been made to determine user presence by serving ads only when a user is active by using the mouse or the keyboard to make such a determination.

Embodiments recognize Targeted Online Advertisements. Targeted advertising is a type of advertising whereby advertisements may be placed so as to reach consumers based on various traits such as demographics, psychographics, behavioral variables (e.g., such as product purchase history), or other second-order activities which may serve as a proxy for these consumer traits. Embodiments recognize that most targeted new media advertising currently uses second-order proxies for targeting, such as tracking online or mobile web activities of consumers, associating historical webpage consumer demographics with new consumer web page access, using a search word as the basis for implied interest, and/or contextual advertising.

Addressable advertising systems may serve ads directly based on demographic, psychographic, and/or behavioral attributes that may be associated with the consumer(s) exposed to the ad. These systems may be digital and/or may be addressable (and in some embodiments perhaps must be addressable) in that the end point which may serve the ad (e.g., set-top box, website, or digital sign) may be capable of rendering an ad independently of any other end points, perhaps based on consumer attributes specific to that end point at the time the ad is served, among other factors. Addressable advertising systems may use consumer traits associated with the end point or end points as the basis for selecting and/or serving ads.

Embodiments recognize Demographic Estimation. The value of targeted advertisements may be substantially greater than network wide ads. The specificity with which the targeting is performed may be useful. Embodiments recognize techniques for estimation of age from facial stills. Embodiments recognize approaches to estimating other anthropometric parameters such as race, ethnicity, etc. These techniques may rely on image data as an input, perhaps for example in order to estimate demographic/anthropometric parameters. There are also approaches to demographic age estimation based on other sensor inputs, such as for example accelerometers, gyroscopes, IR cameras, etc.

Embodiments recognize that accelerometers may be used to monitor a user's essential physiological kinetic tremor which has characteristics that may correlate to age. Embodiments recognize the use of a smart phone platform for tremor parameter estimation. Other sensors (e.g., gyroscope) may also be used to obtain and/or complement this information. Additional demographic data, the accelerometer data may be mined for gender, height, and/or weight.

Embodiments contemplate that detection of user presence, his/her attention to visual content, and/or demographic and/or anthropometric information can be useful for introducing a new (e.g., heretofore undefined) category of ad impressions “certified ad impressions” (CAI) (a phrase used for explanation and not limitation), which can provide amore accurate basis for measuring effectiveness and/or successful reach of ads to target markets and/or derivation of compensation for their placements. Embodiments contemplate one or more techniques by which such certified ad impressions (CAT) can be obtained and/or used in systems for delivery of content (e.g., visual content) to the end users.

The techniques described herein may be used separately or in any combination. In some embodiments, the respective techniques may result in varying degrees of certainty of ad verification. The degree of certainty may also be computed and/or reported by the ad impression verification system. One or more embodiments described herein contemplate details on the information that clients may generate to enable ad impression verification. Embodiments contemplate client-side techniques as well as server-side techniques.

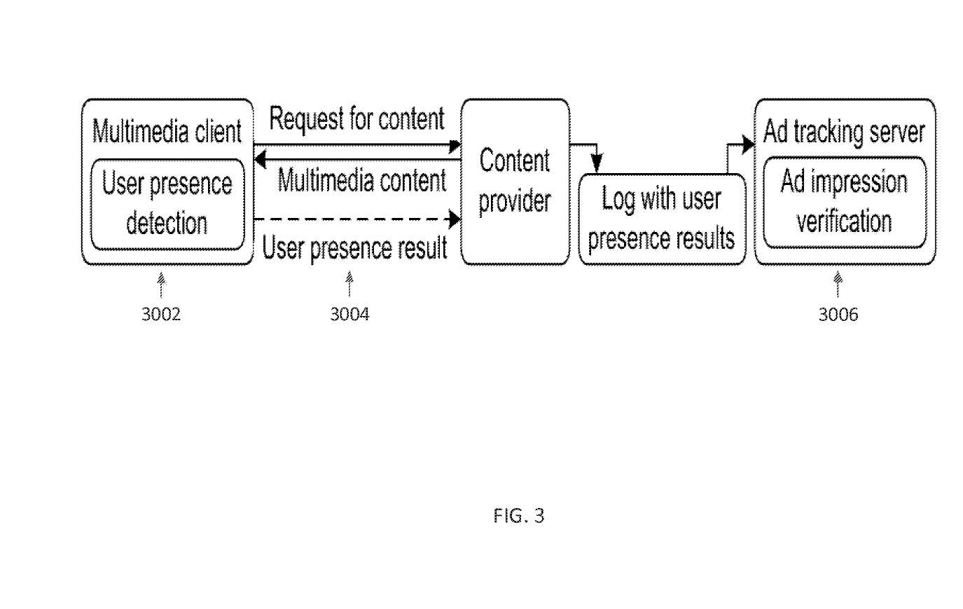

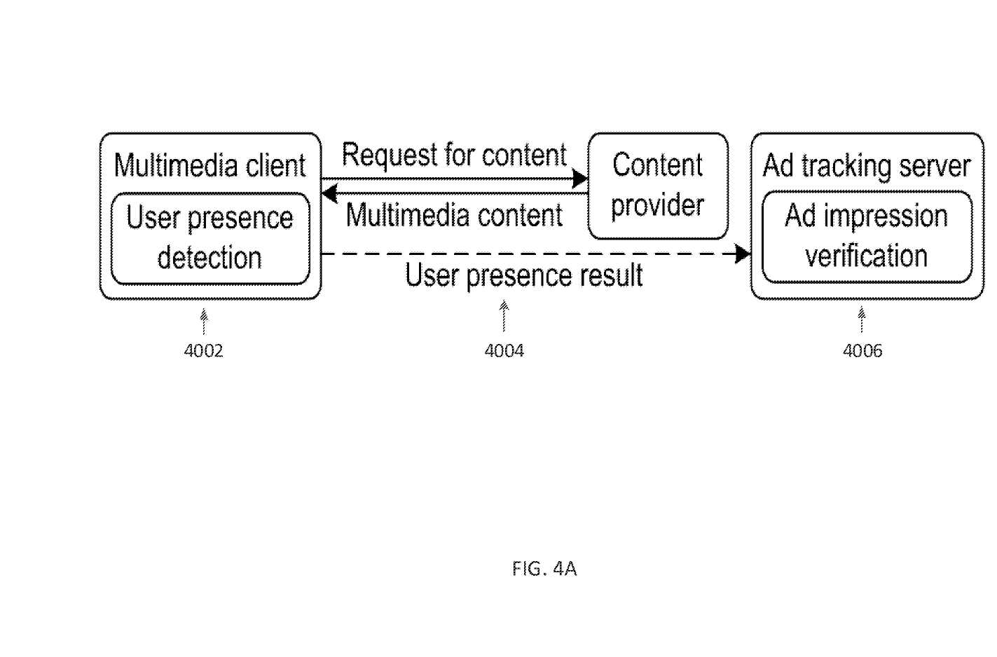

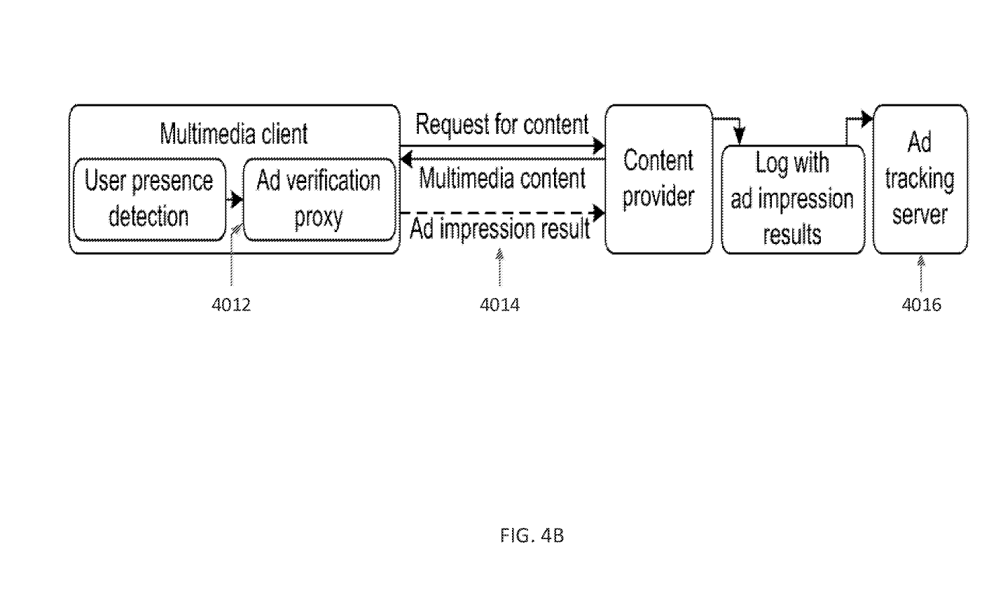

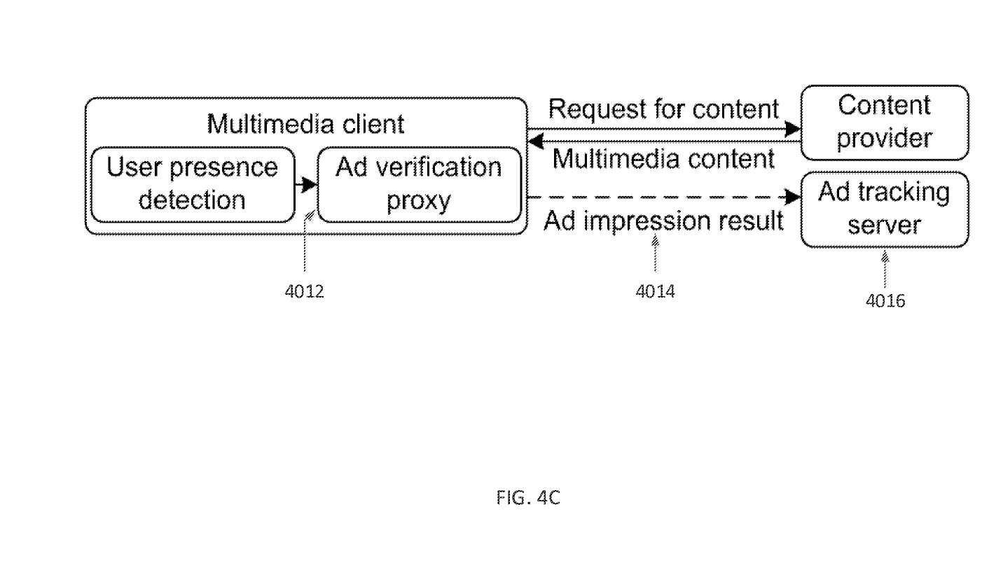

One or more embodiments contemplate client-side solutions. In one or more embodiments, user presence detection may be performed at the reproduction end 3002, as shown in the example of FIG. 3. In such scenarios, among others, the information about user presence may be sent back to the content server or provider at 3004 so that verification may be performed. The information may be sent in-band (as part of a subsequent request), or it may be sent out-of-band (as a separate transaction). User, presence information may be stored at the content server, then may be (e.g., periodically) retrieved by and/or sent to an ad impression verification system 3006 where this information may be used to determine user presence at the time the ad was displayed. In some embodiments, the information about user presence 4004 may be signaled directly from the client 4002 to an ad agency's server 4006 as depicted in FIG. 4A.

Referring to FIGS. 4B and 4C, in some embodiments, ad impression verification may be performed by a proxy 4012 at the client, perhaps instead of sending user presence results to the ad tracking server, for example. In such scenarios, among others, the proxy 4012 at the client may determine whether the user was present when the ad was playing, what ad was playing, and/or how/when/where to report the results 4014 to ad server 4016. In some embodiments, such techniques may free the server from performing these tasks for a potentially large number of clients. The system diagrams with examples of ad verification proxy 4012, at the client are shown in FIG. 4B and FIG. 4C.

One or more embodiments contemplate server-side solutions. Some embodiments contemplate techniques for user presence detection that might not require any changes to the multimedia client.

One or more embodiments may be used in a variety of multimedia delivery frameworks, including but not limited to IPTV, progressive download, and/or bandwidth adaptive streaming. One or more embodiments may also be used with existing cable TV (or even broadcast TV) by capturing user presence detection information (e.g., in a set-top box or other device) and, either continuously and/or periodically (e.g., daily or weekly) uploading this information via the Internet or other data network to an ad agency server.

One or more embodiments contemplate using camera and/or IR imaging devices in reproduction devices. In one or more embodiments, it may be assumed that a mobile and/or home multimedia device (television, monitor, or set top box may include a provision for monitoring viewers that are within the field of view of a camera(s). A picture (or series of pictures) may be taken using the camera(s), followed by application of computer vision tools (e.g., face and facial feature detectors) for detecting the presence and/or demographics of viewers.

Embodiments contemplate that specific tools for user presence and/or attention detection can include face detection algorithms (e.g. Viola-Jones framework). Certain human body features—such as eyes, nose, etc., may be further detected and/or used for increasing assurance that a detected user is facing the screen while an ad is being played. Eye tracking techniques may be used to ensure viewers are actually watching the screen. The duration of time for which a user was detected facing the screen during ad playback can be used as a component metric of a user's interest/attention to the ad content. Human body feature detection and/or eye tracking may be used, perhaps to further improve accuracy of results among other reasons.

Techniques like face detection and/or human body feature detection may return the detection result, perhaps along with the probability that the detection is correct. In particular, face detection algorithms may be sensitive to occlusion (e.g., part of the face is not visible), illumination, and/or expression. Some face detection implementations may provide probability as part of their results. For example, Android's face detection API returns a confidence factor between 0 and 1 which indicates how certain what has been found is actually a face. This is also the case for OpenCV's face detection API. Embodiments contemplate that this probability may be used by the ad verification system to classify and/or rank the results and/or take further actions (e.g., bill high probability results at a higher rate).

Embodiments recognize techniques for demographic data estimation. In some embodiments, perhaps following an ad impression, among other scenarios, verification of the ad impression and/or estimated user demographics, e.g., age, gender, ethnicity, etc., may be passed to the ad agency via the content server or directly to an agency server. This information may be used by the agency to assess whether their ads are reaching their desired target market segment.

In some embodiments, it may be possible to use advanced computer vision techniques for recognizing emotion from facial expressions. The results for emotion may also be reported to the ad verification system where they could be used to determine the impact of an ad campaign.

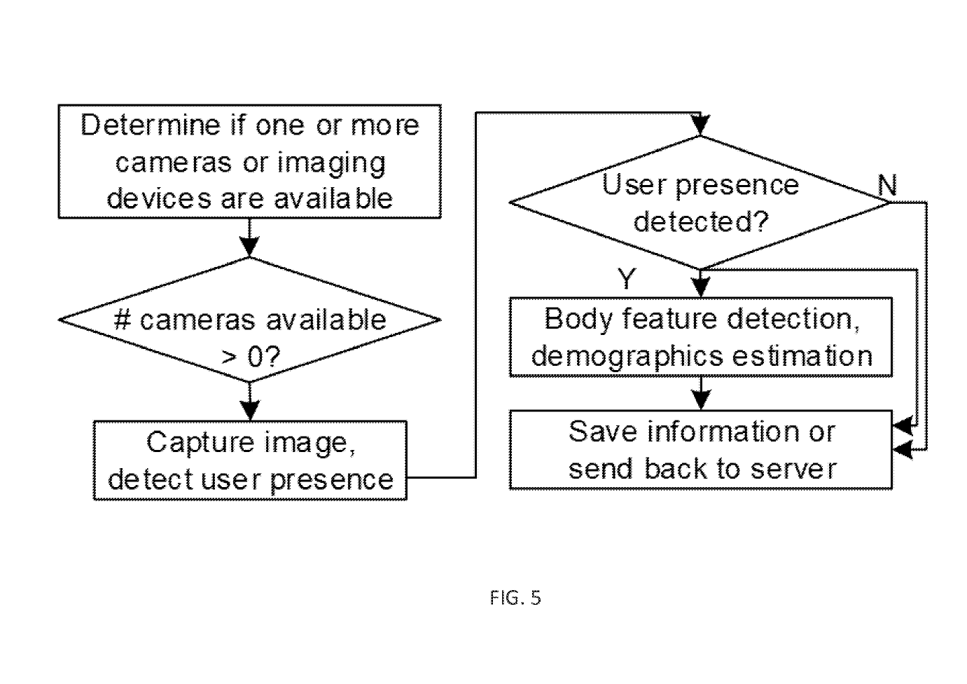

One or more embodiments may be used with certain TVs and/or gaming consoles (e.g., Xbox/Kinect) that may be equipped with cameras and/or IR laser and/or sensors for gesture recognition. In such scenarios, the functions of user presence detection and/or pose estimation may already be implemented by gaming consoles and this information may be used as input. FIG. 5 illustrates a flow chart of an example implementation of user presence detection using camera or imaging devices.

In one or more embodiments, a “User Presence Result” that may be sent back by the client may contain one or more of the items listed below. Additional information (e.g., anthropometric, biometric and/or emotional state) obtained using techniques described herein may also be part of the report.

Time, date, channel and/or content being watched;

Whether user presence was detected (e.g., true or false);

Confidence level and/or probability of accuracy of user presence detection; and/or

Estimated demographics data (e.g., if available).

Embodiments recognize privacy concerns by some users. The concern has no technical basis—as imaging devices are not really used to record anything. This concern may gradually disappear as more and more TV devices using cameras for gesture recognitions and gaming enter society. Embodiments contemplate one or more techniques to manage privacy concerns:
Opt-in with remuneration—The user may agree to have his/her ad impression captured in return for some nominal benefit (e.g., credit on cell phone/cable bill, etc.)

Assurance that only non-personal/non user identifying information may be shared; and/or

The front facing camera may be disabled altogether.

In one or more embodiments it may be assumed that a mobile device and/or gaming console control contains a set of sensors capable of detecting movement (e.g., accelerometer, gyroscope). Embodiments recognize the use of an accelerometer to classify the viewing position of a smart phone or tablet, for example: a user is holding the device in hand, the device is on the user's lap (for tablets), the user is in motion, the device has been placed on a stand, or on a table facing up/down. The information of the viewing position may be sent to the ad server and/or content provider where it may be used to verify ad impression. Advertisers may use this information differently. For example, some may verify an ad impression if the user is holding a device in hand (e.g., perhaps only if so), while others may charge different rates depending on the viewing position.

User presence may also be determined by using a microphone, touch sensors, and/or proximity sensors, etc. More uses of sensors are contemplated. For example, one or more of:
The next generation of “smart” headphones comes equipped with proximity sensors to identify whether the user has the headphones on. This information may be used to detect user presence, for example if the headphones are detected to be on the user. In such scenarios, among others, user detection may be useful for audio ads (e.g., radio or streaming services like Pandora). User detection may be useful for video ads, for example if the “smart” headphones are paired and/or connected to a video delivery system;
Other brands of smart headphones can measure biometric data such as heart rate, distance traveled, steps taken, respiration rate, speed, metabolic rate, energy expenditure, calories burned, and/or recovery time, etc. Biometric data (such as respiration rate and heart rate) may be correlated to the emotional state of the user. In such scenarios, among others, data may be used for delivering emotion-specific ads to the user; and/or
Embodiments contemplate that keystroke patterns (e.g., the rhythm at which user types on a keyboard or touch screen) can be used as a biometric identity. Some embodiments can identify which user and/or what kind of user may be using the device, for example if the device (e.g., laptop, tablet, smart phone, etc.) detects and/or records the keystroke pattern. This may be useful if a family shares the same account for receiving multimedia content with ads. Different family members may have very different interests in potential products to be advertised. The key stroke pattern may allow the content provider to more precisely customize the ads based on the actual user. Further, the content provider may build a profile based on historical data for each keystroke identity. Keystroke may be one of the more of general behavioral biometrics. Mouse clicks, touches, and/or acceleration, may also be used as behavioral biometrics. The behavioral biometrics may also indicate a user's emotion: tired, angry, etc. Ads can be customized based on the detected emotion.

One or more embodiments may be used in a home environment, for example as mobile devices are now being used as remote controls for TVs. Similarly, mobile devices may also be used as second screens for delivering video content and/or supplementary information (e.g. scheduling information, program metadata, and/or advertisements) from the Internet and/or by cable TV providers. In such scenarios, among others, sensors may be used to determine user presence. Embodiments contemplate that age estimation can be performed in a number of ways. Gender, height, and/or weight may be estimated in a number of ways as well.

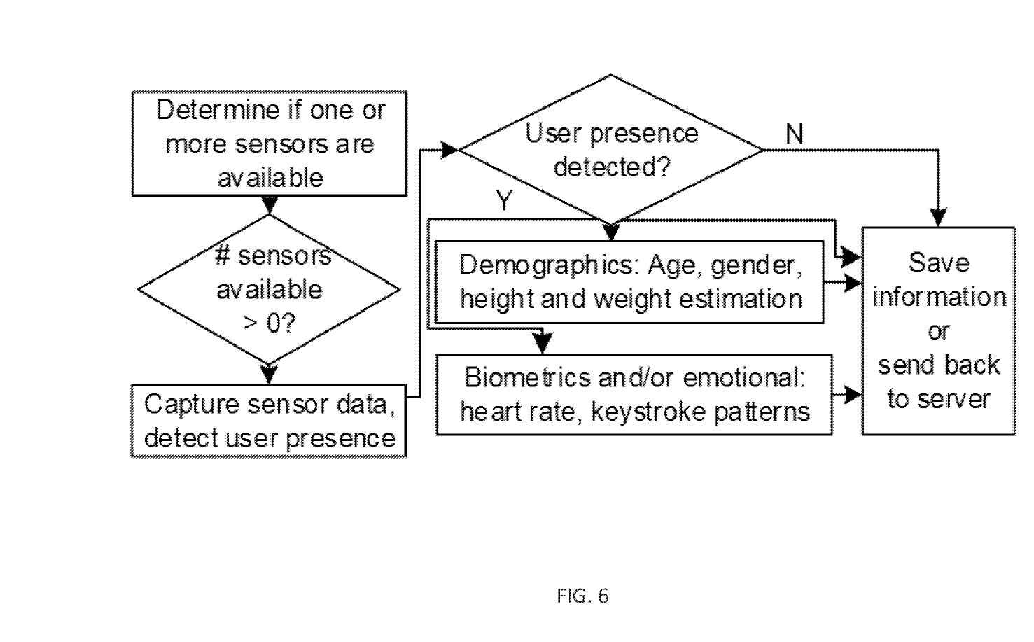

The estimated user age and gender may be passed to the ad agency via the content server or directly to an agency server, perhaps following an ad impression, and/or perhaps in addition to verification of ad impression, among other scenarios. This information may be used by the agency to assess whether their ads are reaching their desired target market segment. A flowchart of an example technique is shown in FIG. 6. A “User Presence Result” may contain information as described herein.

Embodiments contemplate inferring a user's state/activity from his/her input. In one or more embodiments, it may be assumed that the mobile and/or home multimedia device has capabilities for detecting user activity, such as touching the screen to control the media (volume, fast forward, pause or rewind, etc.) and/or by operating a remote control. It can be established that a user is present, perhaps for example when the interaction occurs. That type of interaction may be reported to the ad server and/or content provider, where for example it may be used to verify ad impression.

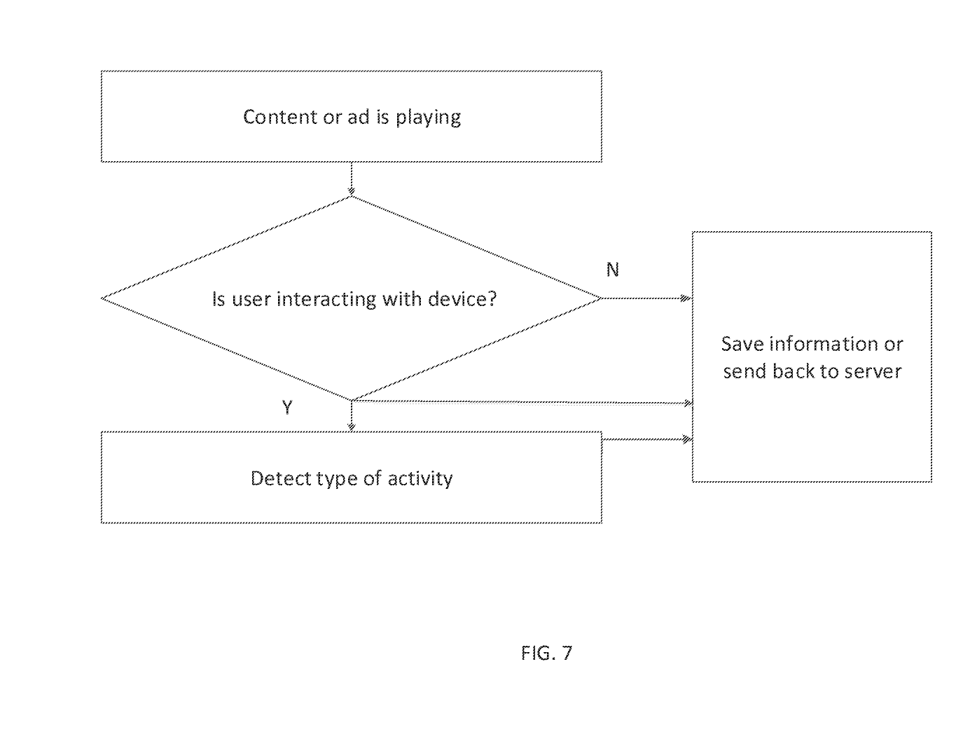

One or more embodiments contemplate adapting the ads based on detected user activity. For example, the user might be multi-tasking and/or the video window that shows ads may be minimized. This information may be reported back to the ad tracking server, perhaps for example when this type of user activity may be detected, and perhaps so that the ad may be made to become more interesting to get the user's attention. The adaptation may be done in real-time and/or after some period of time (e.g., after an activity analysis period, an ad impression analysis period, and/or at a later presentation of the advertisement). An example implementation of such a user presence detection is illustrated in FIG. 7. A “User Presence Result” may contain information as described herein.

Embodiments contemplate using input from microphones. Some TV and gaming consoles come equipped with external or built-in microphones and/or some may use accessories such as a Skype camera that conic equipped with a microphone array. The microphones may be used to capture the viewer's speech, which could then be used to determine user presence. Some recent TVs (e.g., Samsung 2013 TV with “Smart Interaction”) can perform speech recognition requiring the user to speak into the remote control. In some embodiments, perhaps if speech recognition were to be done on the TV set itself, among other scenarios, this may be also be used in determining user presence. Such techniques may be complementary to other techniques described herein, perhaps to further improve the accuracy of determining user presence, among other reasons.

Embodiments contemplate inference of a user presence by analysis of multimedia traffic. One or more embodiments described herein may include detection of the user at the reproduction end (e.g., client-side) and signaling of this information to an ad-verification server. A factor in such embodiments may be a user's privacy concerns, in that a user's presence may be identified at the premises where the user is located (e.g., home or office) and then may be sent to another entity in the network.

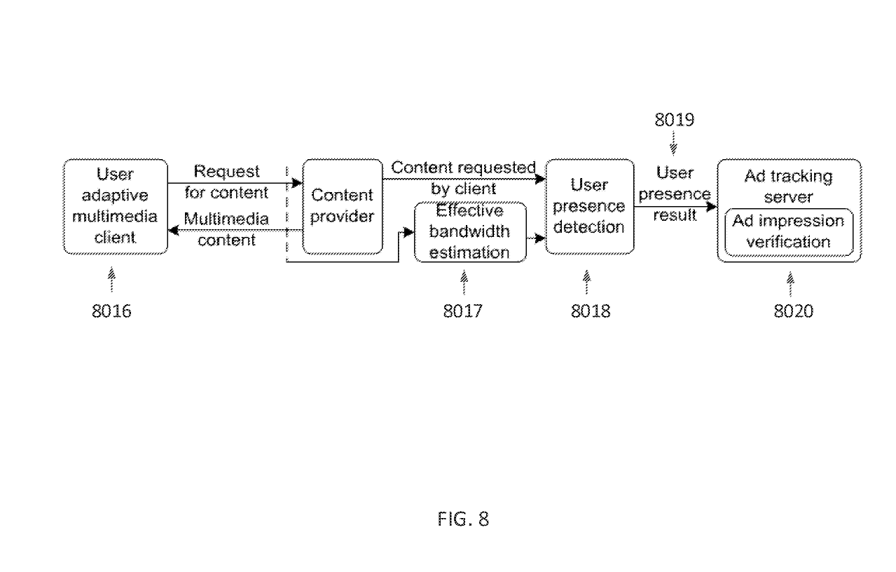

Perhaps to address such privacy issues, among other scenarios, embodiments contemplate that server-side techniques may determine a user presence by indirect means where no additional equipment may be required at the premises, perhaps for example beyond what may be used for conducting a user adaptive video delivery session. FIG. 8 includes a diagram with system architecture that may implement server side user presence detection. In FIG. 8, user presence detection 8018 may be determined and/or a user presence result 8019 may be passed onto an ad tracking server 8020 for ad impression verification. In some embodiments, user presence detection 8018 may be based on client activity as monitored from a user client 8016. In some embodiments, user presence detection 8018 may be based on an effective bandwidth estimation 8017 and/or the effective bandwidth estimation 8017 may be reported along with the user presence result 8019 to the ad tracking server 8020 for ad impression verification. A “User Presence Result” may contain information as described herein.

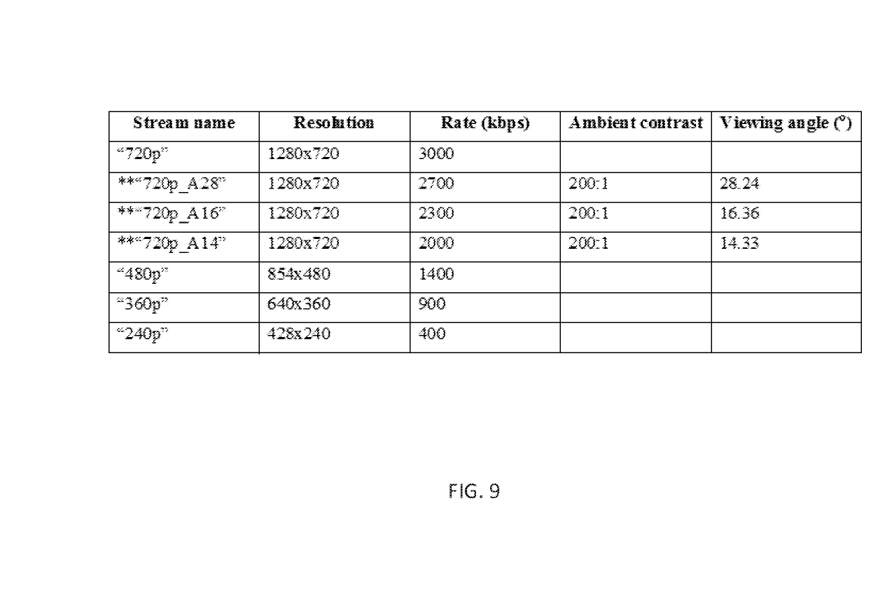

One or more embodiments may assume that the client has built-in logic for user adaptive multimedia delivery and/or may select content adaptively based on a user activity. Embodiments contemplate situations where, for example, a multimedia client may reside in a mobile device, and it may be playing a presentation including the set of example encoded streams illustrated in FIG. 9, where streams marked with “**” are streams that may be produced to accommodate viewing at different viewing distances.

More specifically, streams “720p_A28” and/or “720p_A14” may be suitable for watching videos when a user may be holding the phone in hand, for example. These streams may be selected when the client may have sufficient bandwidth to load them (e.g., perhaps selected only when sufficient bandwidth is available). In some embodiments, the highest rate stream up to a bandwidth capacity that may be available may be loaded, perhaps for example without such a bandwidth estimation.

One or more embodiments on the server side contemplate logic to estimate effective bandwidth of connection between the client and the server. In some embodiments, this can be inferred by analysis of TCP operation in a way it may implement transmission of data from a server to the client. Some embodiments contemplate the comparison of estimated available bandwidth with the rate of video stream(s) requested by the multimedia client.

In some embodiments, perhaps if the result of such a comparison shows that a sufficient amount of bandwidth is available, but the client has decided to select a stream normally dedicated to “in hand” watching of the content (e.g., requests a stream at a lower bit rate than the available bandwidth)—this may imply that the user may be holding the phone when an ad is being rendered, and this in turn, can be used for verification of ad impression, for example.

Embodiments contemplate that smart phones or tablets with user adaptive streaming clients, and the like, may be used in one or more of the described client-side embodiments, as these devices may already have a number of built-in sensors that may be capable of providing more information that can be used to detect user presence. This information may be combined with server-side analytic techniques to improve the accuracy of the detection.

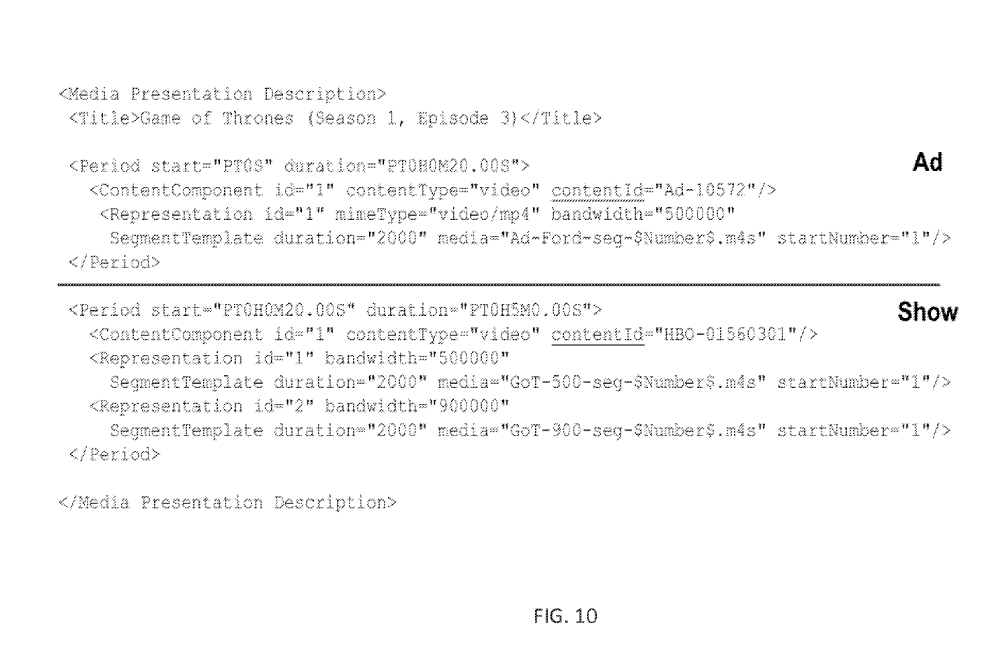

Embodiments contemplate reporting user presence results and/or ad impression verification. Embodiments recognize that in many streaming systems, the client may receive a description at the beginning of the session listing the components of the multimedia presentation (e.g., audio, video, closed caption, etc.) and/or a name of one or more, or each, component, perhaps so they may be retrieved from the content server, among other reasons. Components may be encoded at different levels (e.g., bit rates or quality levels) and/or may be partitioned into segments, for example to enable adaptation (e.g., to bandwidth or quality). In such scenarios, among others, advertisements may be added (e.g., perhaps easily added) to a presentation by inserting them into the description, perhaps at the time when the description may be first retrieved (e.g., for on-demand content) and/or by updating it during the session (e.g., for live events). An example of a multimedia presentation description with an advertisement is shown in FIG. 10.

In some embodiments, the client may retrieve the description from the content provider, and/or may request one or more, or each, of the segments of the ad/show, for example, perhaps to play back the presentation in FIG. 10, among other reasons. Content providers may use a number of ways to identify the content (e.g., using segment names or using fields such as “contentId” in FIG. 10), for example perhaps when preparing the description. Embodiments contemplate that it may be useful to determine (e.g., precisely determine) what segments are being retrieved (e.g., using names and/or ids) and/or who is retrieving them (e.g., by logging the client's id and/or IP address, and/or by using HTTP cookies).

Embodiments contemplate one or more techniques that the client may use for reporting user presence results. These techniques may be used separately or in combination with the client-side techniques described herein. In some embodiments, clients in some server-side techniques might not report back results, perhaps because user presence detection may be performed at the server, among other reasons.

One or more embodiments contemplate that user presence results may be reported to the content provider. In some embodiments, clients may report back user presence results to the content provider (e.g., FIG. 3) using one or more of the techniques described herein.

In some embodiments, results may be reported during a streaming session. Perhaps as part of a streaming session, among other scenarios, the HTTP GET request from the client may include special headers to report the user presence results to the server. The results may refer to a previously fetched ad, and/or they may include sufficient information to identify the ad (e.g., “contentId”), the time it was played, and/or the corresponding user presence results. One or more of these headers may be logged by the server, and/or may be sent to the ad server for ad impression verification, reporting, and/or billing, etc. The following shows a sample set of example custom HTTP headers:
x-user-presence-result-adId: Ad-10572
x-user-presence-result-adTime: “2013-10-10T08:15:30-05:00”
x-user-presence-result-adResults: “presence=true, confidence=90%”

In some embodiments, more detailed results may be provided by the client. For example, clients may provide the actual sensor readings, perhaps so that the ad agency server may perform more sophisticated analysis of the data for determining user presence, for auditing, and/or other purposes.

In some embodiments, the ad server may use the results received from the client, for example to do ad impression verification. Ad agencies may have different criteria to certify impressions. For example, some may require a 90% confidence, perhaps while others may bill advertisers at different rates based on the confidence level.

In some embodiments, one result at a time may be reported, perhaps in scenarios where HTTP headers might not be extended, among other scenarios. Results in headers may be compressed, encoded, encrypted, and/or otherwise obfuscated, perhaps to prevent eavesdropping, among other reasons, for example.

Embodiments contemplate reporting one or more results outside of a streaming session. In some embodiments, a client may report user presence results outside of a streaming session, perhaps to eliminate dependencies and/or to minimize data traffic during streaming, for example, among other reasons. Results may be reported to the server on a per-ad basis, may be aggregated by the client and/or reported periodically (e.g., once every 10 minutes), and/or at the end of a session (e.g., upon user logout). Any method for uploading data may be used by the client, for example using HTTP POST, SOAP/HTTP, FTP, email, and/or any other data transfer method. In Semite embodiments, clients may already know the address of the content provider, perhaps because they requested content from the provider, among other reasons. In some embodiments, techniques may be used to report multiple results, perhaps by sending multiple entries at a time, for example.

In some embodiments, perhaps if using HTTP POST, among other scenarios, the request may use a set of custom HTTP headers, as described herein, and/or may include the results in the body of the HTTP request, as shown in the example below.

POST /ad-impression-verification/verify.asmx/ HTTP/1.1
Host: api.ad-server.com
Content-Type: application/x-www-form-urlencoded
Content-Length: 148
adId=Ad-10572&adTime=”2013-10-10T08:15:30-

05:00”&adResults=”presence=true,confidence=90%”

adId=Ad-24083&...

In some embodiments, a simplified example of using SOAP/HTTP that may be used for user presence results is shown below.

POST /ad-impression-verification/verify.asmx HTTP/1.1
Host: api.ad-server.com
Content-Type: application/soap+xml; charset=utf-8
Content-Length: 457
<?xml version=“1.0” encoding=“utf-8”?>
<soap12:Envelope
xmlns:xsi=“http://www.w3.org/2001/XMLSchema-instance”>

<soap12:Body>
<UserPresenceResult>

<adId>Ad-10572</adId>
<adTime>2013-10-10T08:15:30-05:00</adTime>
<adResults>accelerometerVariance=5.97,ambientLight=90,

audioLevel=45,emotion=happy,demographics=teen</adResults>
</UserPresenceResult>

<UserPresenceResult>

...

</UserPresenceResult>

</soap12:Body>

</soap12:Envelope>

Embodiments contemplate that user presence results may be reported to one or more Ad Agency Servers. In some embodiments, clients may also report user presence results directly to the ad agency server (e.g., FIG. 4A). In such scenarios, among others, clients may learn the address (e.g., URL) of the ad server. This information may be delivered to the client, perhaps as part of the media presentation description, the address may be pre-programmed in the client, and/or clients may fetch it from a well-known location, for example.

As described herein, clients may report user presence results on a per-ad basis, periodically, and/or at the end of the session. Also, clients may use HTTP POST, SOAP/HTTP, FTP, email, and/or any other data transfer method.

Embodiments contemplate an ad verification proxy at the client. In one or more embodiments as described herein, the ad server may process the results received from clients and may verify ad impressions based on the results. The architecture of the system (e.g., of the ad server) may be adjusted (e.g., reduced complexity) by using an ad verification proxy (e.g., FIG. 4B and/or FIG. 4C) that may offload the ad server from performing ad impression verification from a potentially large number of clients.

In some embodiments, the proxy may get the server's address from another module in the multimedia client, perhaps for example if results may be sent to the content provider (e.g., FIG. 4B), among other scenarios. In some embodiments, the proxy may obtain the address as described herein (e.g., may be delivered to the client as part of the media presentation description, the address may be pre-programmed in the client, and/or clients may fetch it from a well-known location), perhaps if results may be sent directly to the ad agency server (e.g., FIG. 4C), among other scenarios.

As described herein, the ad verification proxy may report user presence results on a per-ad basis, periodically, and/or at the end of the session. Also, clients may use HTTP POST, SOAP/HTTP. FTP, email, and/or any other data transfer method.

In one or more embodiments, ad impression results may include the ad ID and/or whether an ad impression may be true or false. Results may also include additional information (e.g., emotional state, demographics, etc.) for reporting, and/or billing, etc. In some embodiments, results may or might not include low-level data (e.g., accelerometer reading, confidence level, etc.), perhaps because the proxy may have already verified the impression. Such data may be reported to the server for auditing and/or other purposes. A sample ad impression example result message sent to the ad agency server using HTTP/SOAP is shown below.

POST /ad-impression-verification/verify.asmx HTTP/1.1
Host: api.ad-server.com
Content-Type: application/soap+xml; charset=utf-8
Content-Length: 457
<?xml version-“1.0” encoding=“utf-8”?>
<soap12:Envelope xmlns:xsi=“http://www.w3.org/2001/XMLSchema-instance”>

<soap12:Body>
<UserPresenceResult>

<adId>Ad-10572</adId>
<adTime>2013-10-10T08:15:30-05:00</adTime>
<adResults>impression=true,emotion=happy,demographics=teen</adResults>

</UserPresenceResult>

<UserPresenceResult>

...

</UserPresenceResult>

</soap12:Body>

</soap12:Envelope>

Embodiments contemplate one or more techniques for calculating an attention score. The attention score may, for example, provide advertisers with a quantification and/or characterization of a user's impression of an advertisement and/or the advertisement's effectiveness.

As described herein, sensors from mobile devices and/or face detection algorithms may provide results that may be reported in a raw format to the content provider and/or ad agency. Embodiments contemplate that raw data may be different across devices (e.g., smartphone, tablet, laptop, etc.) and/or operating systems (e.g., Android, iOS, Windows, etc.). These differences may motivate the content provider and/or ad agency to understand the data being reported and/or to implement one or more algorithms to transform raw data into information that may be used to determine whether an ad impression occurred.

Embodiments contemplate that raw data may be synthesized by one or more techniques, which may provide more useful information that can be used to determine whether an ad impression occurred.

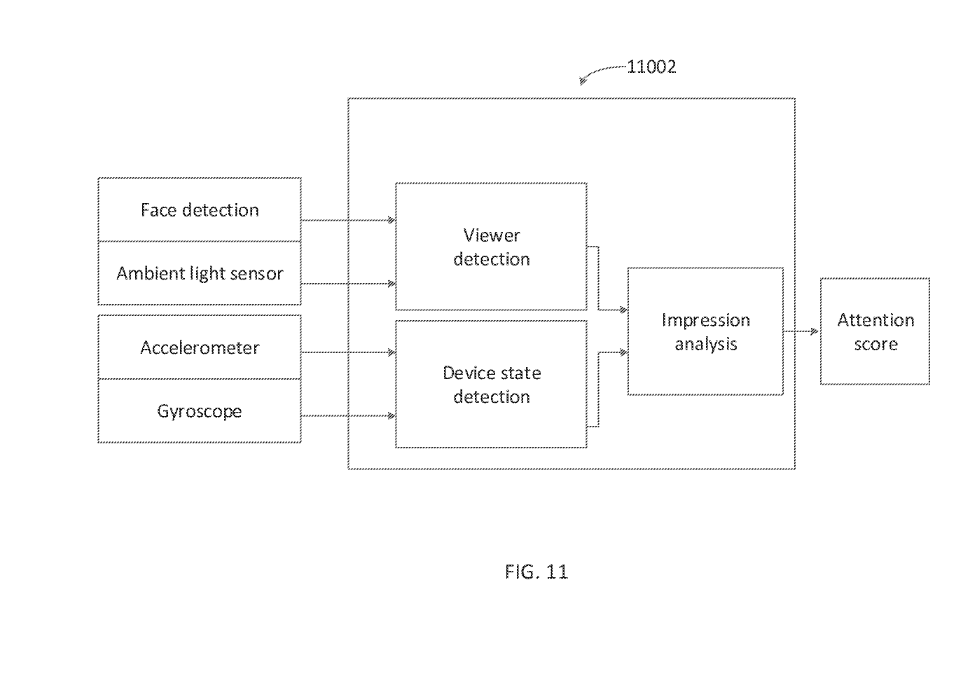

Embodiments contemplate one or more techniques that may synthesize raw data from various sources and/or may output information (e.g., “an attention score”) that may be used for ad impression verification. An example technique is shown in FIG. 11. The module 11002 in the example technique of FIG. 11 may correspond to any of the user presence modules, device interaction modules, and/or ad impression verification modules as shown in FIGS. 3-8, for example.

Embodiments contemplate user presence detection, device interaction detection, and/or ad impression verification for content other than ads, such as but not limited to, for example, TV shows, newscasts, movies, teleconferences, educational seminars, etc. As described herein, audience measurement systems may estimate viewership (e.g., perhaps may only estimate viewership), as determining exact numbers of viewer may be difficult. Embodiments contemplate that one or more techniques may yield more accurate viewership numbers by detecting user presence during the time a show or movie plays.

Embodiments contemplate viewer detection. Embodiments recognize that face detection in frameworks such as Android OS, iOS, or other mobile device operating systems, may provide results with some level of granularity such that these results may be interpreted in a variety of ways. For example, in Android OS, face detection may return one or more of the following set of information for each face detected in a video frame:

Number of faces detected; and/or

For each detected face:
Coordinates of the right and left eye;
Coordinates of the center of the mouth;
A rectangle that bounds the face; and/or
The confidence level for the detection of the face, in the range [1 . . . 100].

Embodiments contemplate that face detection results may be obtained several times per second (e.g., 10-30 face detection results per second). Over the time an ad plays (e.g., 10-60 seconds), a (e.g., relatively large) number of results may be obtained. Embodiments contemplate it may be useful to summarize this information and/or combine it with other data (e.g., sensors) to obtain a more reliable result, perhaps for example to detect user presence.

Embodiments contemplate one or more user detection algorithms. In some embodiments, it may be assumed that the camera in the mobile device is able to provide face detection results. Other devices may be used for user detection, perhaps for example if the camera feature may not be available. In some embodiments, an ambient light sensor may be assumed to be available. Other devices may be used to determine illumination level (e.g., analyzing pixel data from camera), perhaps for example if an ambient light sensor might not available.

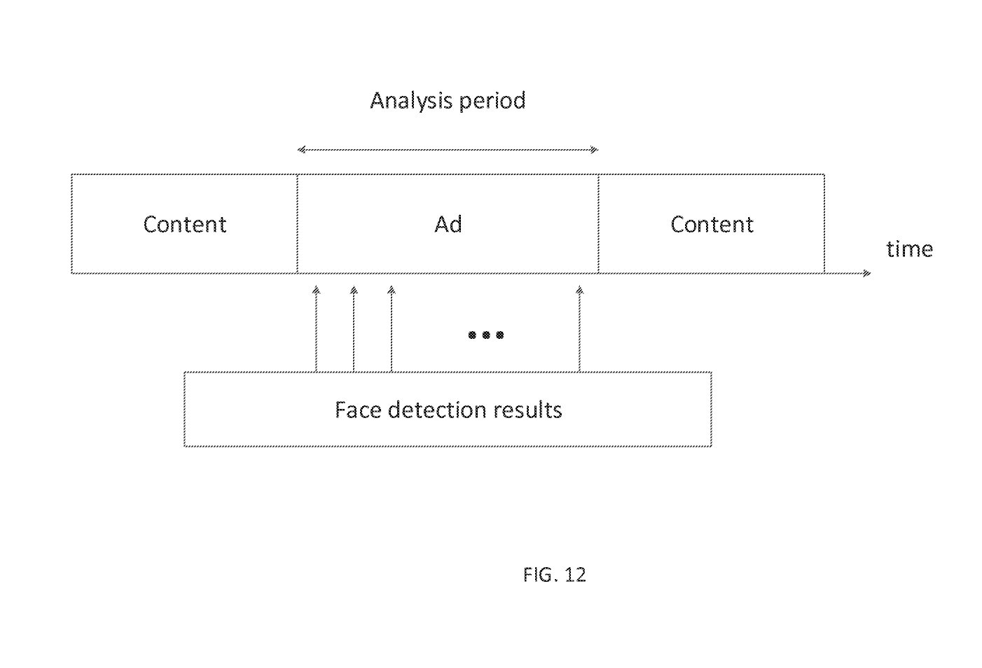

As shown in FIG. 12, face detection results may be obtained over the time the ad plays, which may be in some embodiments, the analysis period. For one or more, or perhaps each, face detection result, the total number of faces for which a confidence level may be above a certain threshold (e.g., 80%) may be determined. In some embodiments, the threshold may be specific to each device model (e.g., as OEMs calculate confidence level differently). In some embodiments, higher/lower thresholds may be used, perhaps for example if higher/lower accuracy may be useful for certain applications.

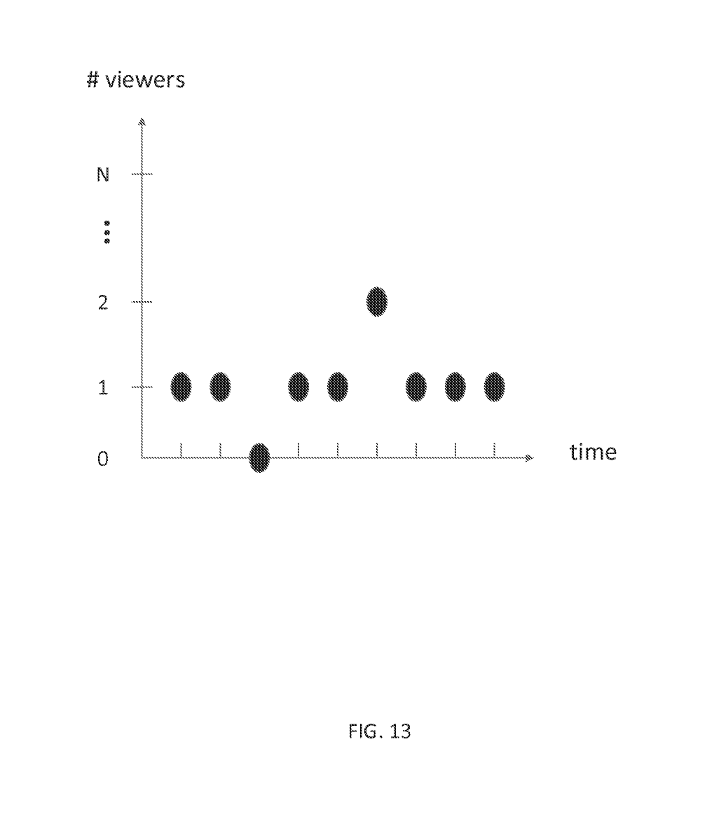

The number of faces that may be detected over the analysis period may vary, perhaps for example due to viewers that may be coming in or out of the field of view of the camera, due to occlusion, rotation, tilt, and/or due to limitations of the face detection algorithm used in the mobile device. An example of face detection is shown in FIG. 13.

In some embodiments, perhaps at least some of the face detection results may be invalid because of poor lighting conditions. That is, for example, perhaps even if camera face detection may be available, but the viewer(s) may be in a dark room, face detection may yield zero faces. In such scenarios, among others, readings from an ambient light sensor (ALS) may be used to determine whether results of face detection may be valid. Other techniques may be for detecting user presence, perhaps for example if the ALS reading may show that the viewing takes place under dark conditions which may render face detection ineffective. In some embodiments, it may be inferred that content on the screen may be difficult to see, perhaps for example if the ALS reading shows that viewing takes place under extremely high lighting conditions (e.g., outdoors on a sunny day). This information may be used to determine whether an ad and/or content is being watched and/or watched effectively.

In some embodiments, perhaps as the number of faces detected may vary over time, a summary of the results may be obtained by using one or more statistical analysis techniques. For example, the average number of viewers over the analysis period may be used to determine user presence. In such scenarios, among others, it may be the case where the average number of viewers is a non-integer number. In some embodiments, rounding or a floor operation may be used to obtain an integer number of viewers, In some embodiments, a median operation may be used to obtain the number of viewers over the analysis period.

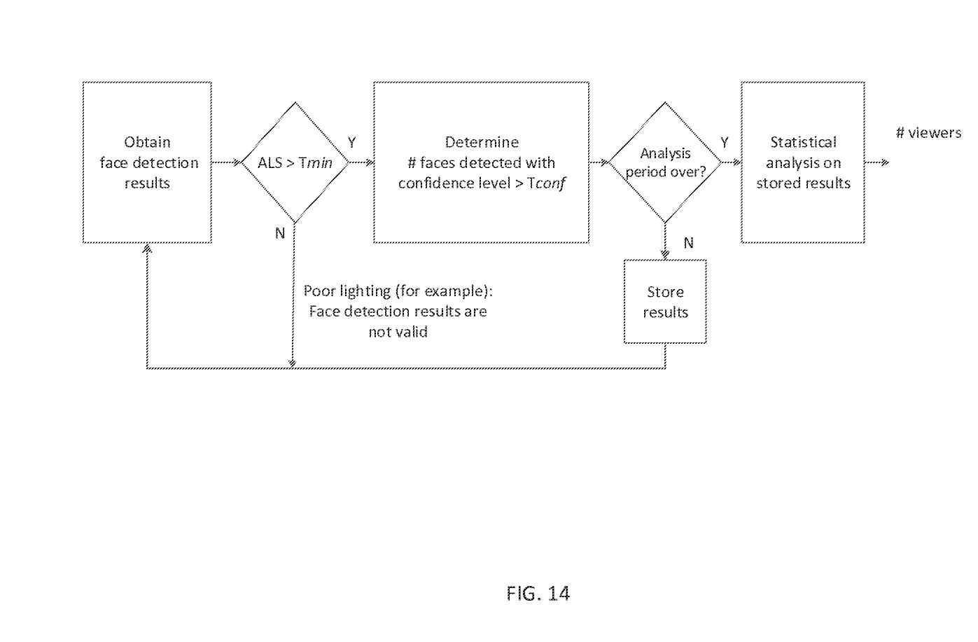

FIG. 14 illustrates an example of an algorithm that may be used for viewer detection. While the output of this algorithm may be the number of viewers over the analysis period, other figures of merit may be obtained as well. For example, the average confidence level of face detection may be reported, perhaps for example instead of using a threshold (e.g., Tconf) to make a binary decision, which may enable the implementation of other algorithms.

In some embodiments, face detection results might not be available to the viewer detection module, perhaps for example because no camera might be available in the device, and/or because the user (e.g., due to privacy concerns or other reasons) might not grant permission for the camera to be used for ad impression verification. In such scenarios, among others, other techniques (e.g., use device state detection) may be used for ad impression verification.

Embodiments contemplate device state detection. Embodiments recognize that sensors such accelerometers and/or gyroscopes may be in modern mobile devices (e.g., Android, iOS and Microsoft smartphones and tablets, etc.) The input from these sensors may be used to determine the device state (e.g., in hand, on a stand, on a table facing up or down, etc.). The device state information may be useful as it may be used to gauge user interest and/or attention while an ad is playing. For example, it may be inferred that a user's attention is likely on the screen of the device, perhaps for example if the user holds the mobile device in the user's hand while the ad is playing. A higher ad impression may be more likely than if the user puts the device on a table, and/or perhaps on a table facing down, for example perhaps if it may be detected that the mobile device is held in the user's hand.

Accelerometer and gyroscope data may be analyzed to determine the device state. Embodiments contemplate that these sensors may produce noisy data, that is, raw data may vary, perhaps significantly, between readings. Advanced signal processing techniques may be used to analyze the data and/or produce a meaningful result. Statistical analysis, among other techniques, may be used.

In statistical analysis, data may be analyzed over a period of time (e.g., one second) to obtain a figure of merit that represents the data. Examples of figure of merits are the average, median, variance, and/or standard deviation. Any of these (or a combination of them or other figures of merit) may be used to represent the data over the analysis period. For device state detection, de variance may be useful as it may capture the variations of the data over the analysis period. A device state may be reliably determined, perhaps for example, based on these variations, in some embodiments, variance may be calculated using the example equation shown below:

$$Variance = ( \sum {x}^{2} ) - \frac{1}{N} ( \sum x ) \cdot ( \sum x )$$

where “x” is the data from accelerometer and/or gyroscope (X, Y and Z axis), and “N” is the number of data points over the analysis period.

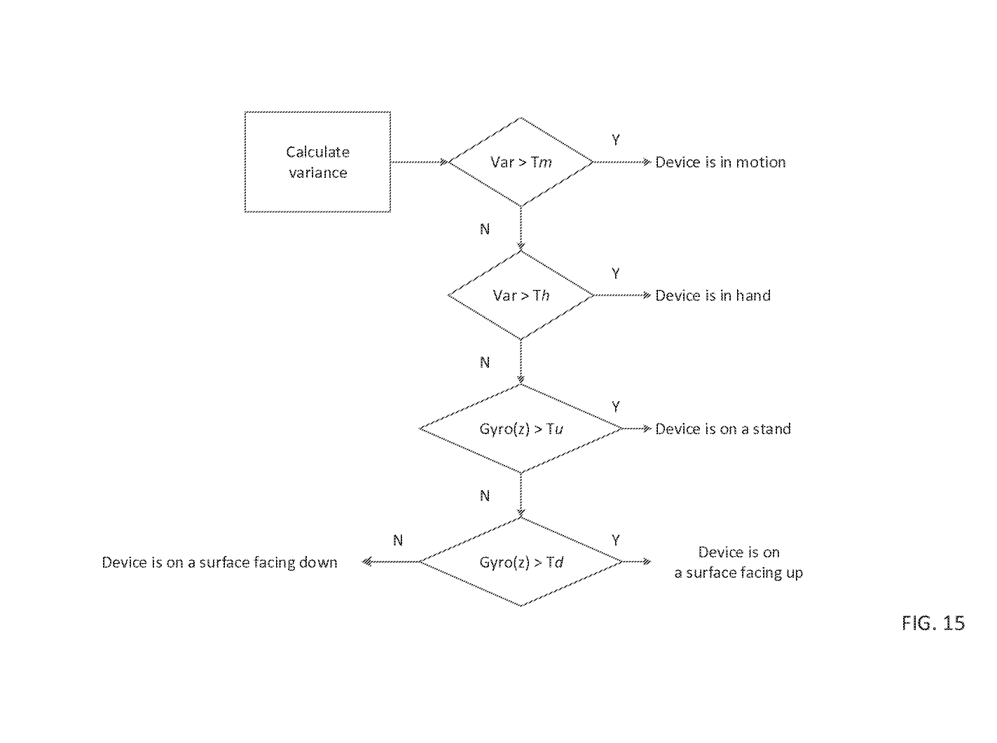

Variance may be used to determine device state, perhaps for example using the classifier shown in FIG. 15. The thresholds Tm, Th, Tu and/or Td, may be chosen, for example based on the range of values that may be provided by the accelerometer and/or gyroscope. The device states shown in FIG. 15 below are examples. Other device states (e.g. device is being held on the user's lap) may also be used. Variance (VAR) (e.g., of either accelerometers and/or position data from gyros) may be used to detect an amount of motion. For example, the variance may be higher, perhaps for example if the device is moving around. Referring to FIG. 15, Tm may be a high threshold—which may be compared to the variance to detect a (e.g., significant) level of motion. For example, this may indicate that a user is in some activity, like walking or jogging.

Again referring to FIG. 15, Th may be a lower threshold for the variance that may correspond to lesser motion (e.g., when a user is holding device in hand to use the device, there may be some motion but not as much as if the user may be walking or jogging).

Embodiments contemplate consideration of “Gyro” sensor data, perhaps for example but not limited to, if the variance may be below Th, which may indicate that motion level is very low (e.g., close to zero). Gyro sensor data may indicate an actual orientation of the device, perhaps using a z-axis Gyro (Gyro(z)), for example. It may be assumed that a device is propped up (e.g., on a stand) and/or may be at a reasonable viewing angle, perhaps for example if the z-axis position may exceed a threshold Tu. This may indicate that a user may have propped up the device to watch the screen.

It may be assumed the device is on a surface facing up, perhaps for example if the z-axis position may be less than Tu and/or may be larger than another threshold Td. In some embodiments, this may be interpreted as a user who may have put down the device and/or might or might not be watching the screen while it is on the surface. Otherwise, the device may be facing down and/or there may be a high probability that the screen may not visible to any users.

Embodiments contemplate ad impression analysis. In some embodiments, the output of the “viewer/user presence detection” modules and/or the “device state detection” modules described herein may be used by the “ad impression verification analysis” modules described herein to calculate an “attention score”. Since the “viewer/user presence detection” and/or “device state detection” modules may output different information, the “ad impression verification analysis” modules may perform different analysis based on the differing inputs.

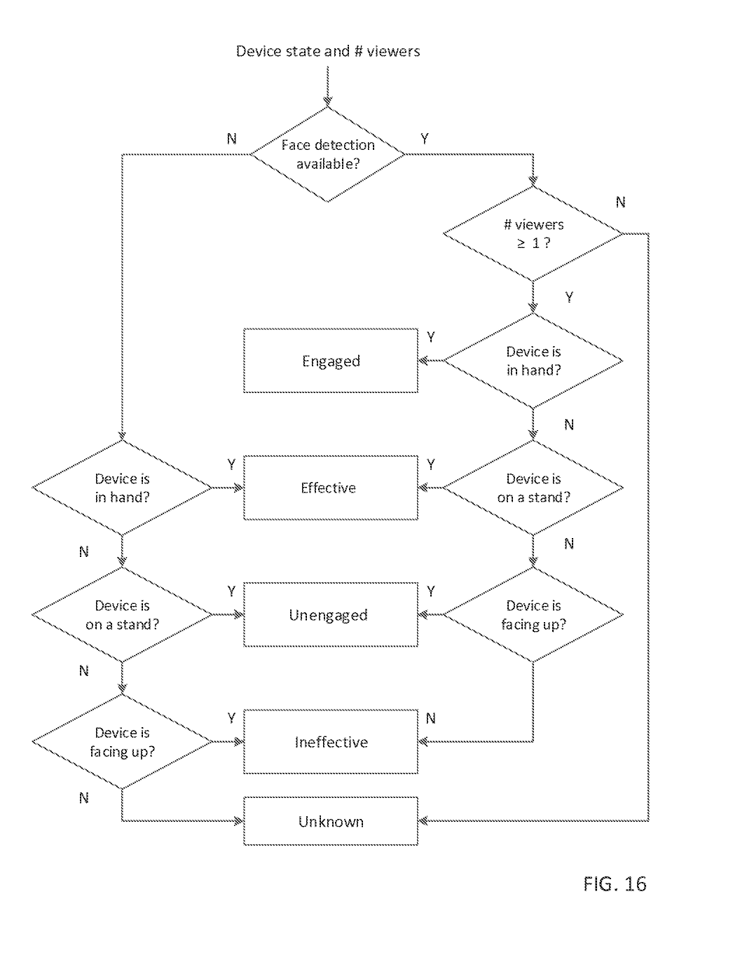

For example, referring to FIG. 16, an “ad impression verification analysis” module may use one or two results as input:
The number of viewers over the analysis period from the “viewer detection” module (if available); and/or
The device state from the “device state detection” module.
   The output of “ad impression verification analysis” may be an “attention score.” in some embodiments, an attention score may be a number, for example, such as an integer in the range [1 . . . 100] that may represent the level of attention of the viewer over the analysis period. In some embodiments, the attention score may by reflected by a confidence percentage or a confidence percentage range (e.g., 80%-90% user/viewer engagement with the advertisement). In some embodiments, the attention score may be one of several states that may represent user attention for the purpose of ad impression.

For example, the attention score may be one of the states listed below Other states are contemplated and may be used.
Engaged (and/or an integer score of 75-100 and/or an 85% confidence percentage, for example): Viewer paid full attention to the ad or content;
Effective (and/or an integer score of 50-74 and/or a 65% confidence percentage, for example): Viewer paid some attention to the ad or content;
Unengaged (and/or an integer score of 25-49 and/or a 35% confidence percentage, for example): Viewer paid little attention to the ad or content;
Ineffective (and/or an integer score of 1-24 and/or a 15% confidence percentage, for example): Viewer paid no attention to the ad or content at all; and/or
Unknown (and/or an integer score of 0 and/or a confidence percentage of zero or substantially zero, for example): It is not possible to accurately determine whether the viewer paid attention to the ad or content.

The example classifier technique such as the one shown in FIG. 16 may be used to determine one or more of the above states, perhaps using information about device state and/or number of viewers. Other classifiers may also be used to determine the attention score, for example.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-20. (canceled)

21. A method of determining a media content impression, the media content communicated via a communication network to a client device, the method comprising:
receiving, via a receiver from the client device, a first data corresponding to a user proximate to the client device during a period of time;
receiving, via the receiver from the client device, a second data corresponding to a state of the client device during the period of time;
receiving, via a receiver from the client device, an indication of at least one specific media content presented by the client device during the period of time, the client device being a multimedia device;
determining, via a processor, a measurement of a user impression of the at least one specific media content based on the first data and the second data, the measurement of the user impression providing an indication of a user attention to the at least one specific media content during the period of time, the period of time corresponding to an analysis period;
storing, in a memory, the measurement of the user impression; and
providing access to the measurement of the user impression via at least a network connection.

22. The method of claim 21, wherein the measurement of the user impression of the at least one specific media content includes a degree of confidence in the user attention to the at least one specific media content.

23. The method of claim 22, wherein the degree of confidence in the user attention to the at least one specific media content includes at least one of: an integer value, a percentage value, or a textual characterization.

24. The method of claim 21, wherein the at least one specific media content is an advertisement.

25. The method of claim 21, wherein the first data includes at least one of: an indication that data regarding user proximity to the client device is unavailable, an indication that at least one user is proximate to the client device, a number of user faces detected by the client device; one or more demographic data of a user detected by the client device, an indication of a user interaction with the client device, or one or more biometric data of a user detected by the client device.

26. The method of claim 21, wherein the client device includes a display and the second data includes an indication of at least one of: the client device is moving, the client device is in a user's hand, the client device is in a stand, the client device is on a surface with the display opposite of the surface, or the client device is on the surface with the display contiguous to the surface.

27. The method of claim 21, further comprising receiving, from the client device, a third data corresponding to the user proximate to the client device during the period of time, the third data including one or more keystroke rhythms of the user, the one or more keystroke rhythms identifying the user as a specific user.

28. The method of claim 27, wherein the determining the measurement of the user impression of the at least one specific media content is further based on the third data.

29. The method of claim 21, wherein the client device is a first client device, the method further comprising receiving, from a second client device, a third data corresponding to the user proximate to the second client device during the period of time,
wherein the indication from the first client device of the at least one specific media content presented by the first client device during the period of time further indicates that at least a part of the at least one specific media content is presented by the second client device during the period of time, and
the determining the measurement of the user impression of the at least one specific media content is further based on the third data.

30. The method of claim 21, further comprising:
requesting the user to authorize sending at least one of the first data or the second data; and
providing the user with a remuneration based on the authorization.

31. A wireless transmit/receive unit (WTRU) in communication with a wireless communication network, the WTRU comprising:
a processor, the processor configured at least to:
identify a first data corresponding to a user proximate to the WTRU during a period of time, the WTRU being a multimedia device; and
identify a second data corresponding to a state of the WTRU during the period of time;
determine at least one specific media content presented by the WTRU during the period of time; and
determine a measurement of a user impression of the at least one specific media content based on the first data and the second data, the measurement of the user impression providing an indication of a user attention to the at least one specific media content during the period of time, the period of time corresponding to an analysis period;
a memory; the memory configured at least to:
store the measurement of the user impression; and
a transmitter, the transmitter configured at least to:
send the measurement of the user impression to one or more server devices.

32. The WTRU of claim 31, wherein the measurement of the user impression of the at least one specific media content includes a degree of confidence in the user attention to the at least one specific media content, the degree of confidence in the user attention to the at least one specific media content including at least one of: an integer value, a percentage value, or a textual characterization.

33. The WTRU of claim 31, wherein the one or more servers include at least one of: a provider of the at least one specific media content, or a producer of the at least one specific media content.

34. The WTRU of claim 31, wherein the first data includes at least one of: an indication that data regarding user proximity to the WTRU is unavailable, an indication that at least one user is proximate to the WTRU, a number of user faces detected by the WTRU; one or more demographic data of a user detected by the WTRU, an indication of a user interaction with the WTRU, or one or more biometric data of a user detected by the WTRU.

35. The WTRU of claim 31, wherein the WTRU has a display and the second data includes an indication of at least one of: the WTRU is moving, the WTRU is in a user's hand, the WTRU is in a stand, the WTRU is on a surface with the display opposite of the surface, or the WTRU is on the surface with the display contiguous to the surface.

36. A method of modifying a media content, the media content communicated via a communication network to a client device, the method comprising:
receiving, via a receiver from the client device, an indication of at least one specific media content presented by the client device during a period of time;
generating, via a processor, a measurement of a user impression of the at least one specific media content, the measurement of the user impression providing an indication of a user attention to the at least one specific media content during the period of time, the period of time corresponding to an analysis period;
determining, via the processor, an adjustment of the at least one specific media content based on the measurement of the user impression, the adjustment forming an adjusted specific media content; and
providing the adjusted specific media content to the client device during at least one of: the period of time or another period of time.

37. The method of claim 36, wherein the measurement of the user impression is based on a first data, the first data including at least one of: an indication that data regarding user proximity to the client device is unavailable, an indication that at least one user is proximate to the client device, a number of user faces detected by the client device; one or more demographic data of a user detected by the client device, an indication of a user interaction with the client device, or one or more biometric data of a user detected by the client device.

38. The method of claim 37, wherein the client device includes a display and the measurement of the user impression is further based on a second data, the second data including an indication of at least one of: the client device is moving, the client device is in a user's hand, the client device is in a stand, the client device is on a surface with the display opposite of the surface, or the client device is on the surface with the display contiguous to the surface.

39. The method of claim 36, wherein the measurement of the user impression of the at least one specific media content includes a degree of confidence in the user attention to the at least one specific media content.

40. The method of claim 39, wherein the degree of confidence in the user attention to the at least one specific media content includes at least one of: an integer value, a percentage value, or a textual characterization.
